(19) United States
(12) Patent Application Publication
(10) Pub. No.: US 2024/0369980 A1
(43) Pub. Date: Nov. 7, 2024

(54) A METHOD AND AN APPARATUS FOR ESTIMATING QUALITY PARAMETERS RELATED TO A PRODUCT OR A FEED OF PROCESSING OF ORGANIC SUBSTANCES

(71) Applicant: Neste Oyj, Espoo (FI)

(72) Inventors: Hans AALTO, Porvoo (FI); Samuli BERGMAN, Porvoo (FI); Jan PACESA, Porvoo (FI); Amir SHIRDEL, Porvoo (FI)

(73) Assignee: Neste Oyj, Espoo (FI)

(21) Appl. No.: 18/683,801

(22) PCT Filed: Mar. 3, 2023
(86) PCT No.: PCT/FI2023/050124

§ 371 Date: Feb. 15, 2024

(30) Foreign Application Priority Data
Mar. 9, 2022 (FI) 20225207

(51) Int. Cl. G05B 13/04; C10G 7/12

(52) U.S. Cl. CPC G05B 13/042; C10G 7/12

(57) ABSTRACT

An apparatus for estimating a quality parameter related to a product or a feed of processing of organic substances includes measurement devices for measuring density and temperature of the product or the feed. A data processing system computes an estimate for the quality parameter based on an estimation formula whose input variables include the measured density and temperature. The data processing system repeatedly updates the model parameters of the estimation formula based on received laboratory test results and on densities and temperatures of the product or the feed.

### FIELD OF THE DISCLOSURE

The disclosure relates generally to processing organic substances, such as tall oil, heavy gas oil, and mineral or synthetic base oil. More particularly, the disclosure relates to a method and to an apparatus for estimating at least one quality parameter related to a product or a feed of processing of organic substances. Furthermore, the disclosure relates to a method and to a system for processing organic substances. Furthermore, the disclosure relates to a computer program for estimating at least one quality parameter related to a product or a feed of processing of organic substances.

### BACKGROUND

The quality of a product obtained by processing organic substances is an important factor in terms of customer's requirements and a process control point of view. The quality of the product should satisfy customer's specifications and support the process control. Correspondingly, the quality of a feed of processing of organic substances may be as well an important factor from the viewpoint of process control. For example, process control of a tall oil distillation process needs one or more quality parameters which is/are indicative of quality of one or more distillation products and/or quality of crude tall oil used as the feed of the distillation process. The quality parameters may express for example: i) rosin product softening point, i) rosin product rosin acid content, iii) rosin acid content of a fatty acid product, iv) rosin acid content of crude fatty acid, and/or v) rosin acid content of the crude tall oil.

Different methods have been developed to obtain quality parameters of the kind mentioned above. The quality parameters can be obtained for example with on-line measurements based on the Near-infrared “NIR” spectroscopy. The method based on the NIR spectroscopy is however quite expensive in terms of both investment costs and operational costs. For another example, each quality parameter can be obtained indirectly based on density and temperature measured from a product or a feed under consideration and on a fixed-parameter regression model which gives each desired quality parameter as a function of the measured density and temperature. The publication U.S. Pat. No. 7,208,570 describes a method that uses the fixed-parameter regression model and, in addition, information on a harvest time of wood used to produce crude tall oil in order to improve the accuracy of the inferred one or more quality parameters. An inherent challenge related to the method described in U.S. Pat. No. 7,208,570 is that information about the harvest time is not always available.

### SUMMARY

The following presents a simplified summary to provide a basic understanding of some embodiments of the invention. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

In accordance with the invention, there is provided a new method for estimating at least one quality parameter related to a product or a feed of processing of organic substances. The processing of the organic substances can be for example distillation of tall oil or fractionation of heavy gas oil or base oil.

A method according to the invention comprises:
repeatedly measuring density and temperature of the product or the feed,
repeatedly computing an estimate for the at least one quality parameter based on an estimation formula whose input variables comprise the measured density and the measured temperature,
repeatedly receiving laboratory test results indicative of the at least one quality parameter, and
repeatedly updating model parameters of the estimation formula based on i) the received laboratory test results and on ii) measured values of the input variables of the estimation formula corresponding to the received laboratory test results, the model parameters defining a dependence of changes of the estimate on changes of the input variables comprising the density and the temperature.

As the model parameters of the estimation formula are repeatedly updated based on the laboratory test results during the processing of the organic substances, the estimation formula is kept commensurate with the laboratory test results and thus there is no need for re-modeling or other adjustment of the estimation formula. Thus, the accuracy of the method can be kept sufficiently good without a need for harvest time information and/or other data that may not be available. Furthermore, costs of the method according to the invention can be significantly less than for example those of the Near-infrared “NIR” spectroscopy in terms of both investment costs and operational costs.

In accordance with the invention, there is also provided a new method for processing organic substances such as tall oil or heavy gas oil. The method comprises:
supplying a feed containing the organic substances into processing equipment, e.g. a distillation column, where at least one product is obtained from the organic substances,
repeatedly estimating, with a method according to the invention, at least one quality parameter related to the at least one product or to the feed, and
controlling conditions within the processing equipment based on the estimated at least one quality parameter.

In accordance with the invention, there is also provided a new apparatus for estimating at least one quality parameter related to a product or a feed of processing of organic substances. An apparatus according to the invention comprises:
measurement devices configured to repeatedly measure density and temperature of the product or the feed, and
a data processing system configured to:
   repeatedly compute an estimate for the at least one quality parameter based on an estimation formula whose input variables comprise the measured density and the temperature,
   repeatedly receive laboratory test results indicative of the at least one quality parameter, and
   repeatedly update model parameters of the estimation formula based on i) the received laboratory test results and on ii) measured values of the input variables of the estimation formula corresponding to the received laboratory test results, the model parameters defining a dependence of changes of the estimate on changes of the input variables comprising the density and the temperature.

In accordance with the invention, there is also provided a new system for processing organic substances. A system according to the invention comprises:
processing equipment configured to receive a feed containing the organic substances and obtain at least one product from the organic substances,
an apparatus according to the invention and configured to repeatedly estimate at least one quality parameter related to the at least one product or to the feed, and
a process controller configured to control conditions within the processing equipment based on the estimated at least one quality parameter.

In accordance with the invention, there is also provided a new computer program for estimating at least one quality parameter related to a product or a feed of processing of organic substances. A computer program according to the invention comprises computer executable instructions for controlling a programmable data processing system to:
repeatedly receive measured values of density and temperature of the product or the feed, and
repeatedly compute an estimate for the at least one quality parameter based on an estimation formula whose input variables comprise the measured density and the temperature,
repeatedly receive laboratory test results indicative of the at least one quality parameter, and
repeatedly update model parameters of the estimation formula based on i) the received laboratory test results and on ii) measured values of the input variables of the estimation formula corresponding the laboratory test results, the model parameters defining a dependence of changes of the estimate on changes of the input variables comprising the density and the temperature.

In accordance with the invention, there is provided also a new non-volatile computer readable medium, e.g. a compact disc “CD”, that is encoded with a computer program according to the invention.

In accordance with the invention, there is provided also a new computer program product. The computer program product comprises a non-volatile computer readable medium according to the invention.

Exemplifying and non-limiting embodiments of the invention are described in accompanied dependent claims.

Various exemplifying and non-limiting embodiments of the invention both to constructions and to methods of operation, together with additional objects and advantages thereof, will be best understood from the following description of specific exemplifying embodiments when read in connection with the accompanying drawings.

The verbs “to comprise” and “to include” are used in this document as open limitations that neither exclude nor require the existence of also un-recited features.

The features recited in the accompanied dependent claims are mutually freely combinable unless otherwise explicitly stated.

Furthermore, it is to be understood that the use of “a” or “an”, i.e. a singular form, throughout this document does as such not exclude a plurality.

### BRIEF DESCRIPTION OF THE FIGURES

Exemplifying and non-limiting embodiments of the invention and their advantages are explained in greater details below in the sense of examples and with reference to the accompanying drawings, in which:

FIG. 1 shows a flowchart of a method according to an exemplifying and non-limiting embodiment for estimating at least one quality parameter related to a product or a feed of processing of organic substances.

FIGS. 2a, 2b, and 2c illustrate functionality of a method according to an exemplifying and non-limiting embodiment for estimating a quality parameter related to a product or a feed of processing of organic substances, and

FIG. 3 illustrates a system for processing organic substances, the system comprising an apparatus according to an exemplifying and non-limiting embodiment for estimating at least one quality parameter related to a product or a feed of the processing of the organic substances.

### DESCRIPTION OF EXEMPLIFYING EMBODIMENTS

The specific examples provided in the description below should not be construed as limiting the scope and/or the applicability of the accompanied claims. Lists and groups of examples provided in the description are not exhaustive unless otherwise explicitly stated.

A method according to an exemplifying and non-limiting embodiment for processing organic substances comprises supplying a feed that contains the organic substances into processing equipment where at least one product is obtained from the organic substances. The organic substances can be for example such that its molecules have at least 10 carbon atoms. The organic substances can be for example tall oil, heavy gas oil, or alphaolefin monomers and alphaolefin oligomers, and the product can be for example a fraction separated from the organic substances. The processing equipment can be for example a distillation column or a chemical reactor or a combined process unit comprising from one to several reactors and/or from one to several distillation columns. The method further comprises repeatedly estimating, according to an embodiment of the invention, at least one quality parameter Q related to the at least one product or to the feed. The at least one quality parameter Q is estimated based on density p and temperature T measured from the product or the feed under consideration. Each quality parameter Q can be indicative of for example i) rosin product softening point, i) rosin product rosin acid content, iii) rosin acid content of a fatty acid product, iv) rosin acid content of crude fatty acid, v) rosin acid content of crude tall oil, vi) a color index of heavy gas oil or base oil, or vii) weight fractions of compounds in polyalphaolefin products or intermediates. The method further comprises controlling conditions within the processing equipment based on the estimated at least one quality parameter Q. The conditions within the processing equipment can be controlled for example by controlling a volume or mass flow rate of the feed into the processing equipment, a volume or mass flow rate of the one or more products out from the processing equipment, and/or by controlling temperature, pressure, a feed rate of catalysts and/or inhibitors into the processing equipment, and/or other conditions prevailing in the processing equipment.

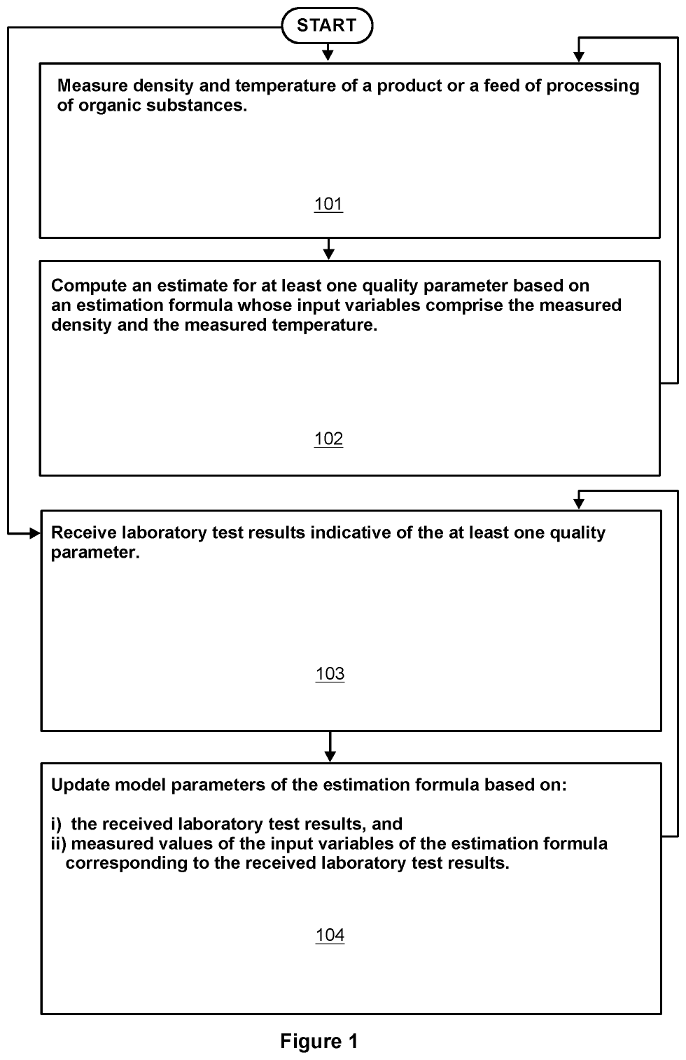

FIG. 1 shows a flowchart of a method according to an exemplifying and non-limiting embodiment for estimating the above-mentioned at least one quality parameter Q. The method comprises the following actions:
action 101: repeatedly measuring the density p and the temperature T of the product or the feed under consideration,
action 102: repeatedly computing the estimate for the at least one quality parameter Q based on an estimation formula F(ρ, T, . . . , p₁, p₂, . . . ) whose input variables comprise the measured density ρ and the measured temperature T,
action 103: repeatedly receiving laboratory test results Q_{Lab} indicative of the at least one quality parameter Q, and
action 104: repeatedly updating model parameters p₁, p₂, . . . of the estimation formula based on i) the received laboratory test results and on ii) measured values of the input variables of the estimation formula corresponding to the received laboratory test results, the model parameters defining a dependence of changes of the estimate on changes of the input variables which comprise the density and the temperature.

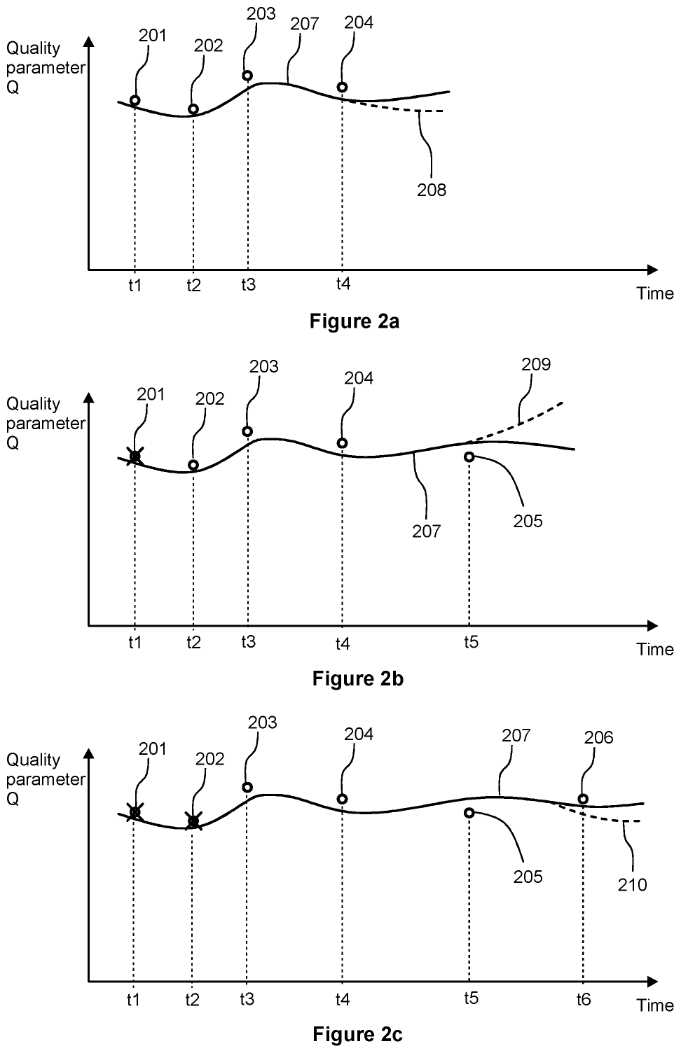

The functionality of the above-described method for estimating the quality parameter Q is illustrated in FIGS. 2a. 2b, and 2c. Laboratory test results indicative of the quality parameter Q are depicted with small circles, and the computed estimate of the quality parameter Q as a function of time is depicted with a solid curve 207. FIG. 2a shows a situation in which laboratory test results 201, 202, 203, and 204 have been received at time moments t1, t2, t3, and t4, respectively. FIG. 2b shows a situation in which a next laboratory test result 205 has been received at a time moment t5, and FIG. 2c shows a situation in which a still next laboratory test result 206 has been received at a time moment t6. After receiving each laboratory test result, the model parameters can be updated based on the most recently received laboratory test result and a predetermined number of earlier received laboratory test results. For example, in the situation shown in FIG. 2a, the model parameters can be updated based on i) the most recently received laboratory test result 204 and ii) the three earlier received laboratory test results 201-203. In FIG. 2a, a dashed line curve 208 illustrates how the computed estimate of the quality parameter Q would behave if the model parameters were not updated after receiving the laboratory test result 204. In the situation shown in FIG. 2b the model parameters can be updated for example based on i) the most recently received laboratory test result 205 and ii) the three earlier received laboratory test results 202-204, and in the situation shown in FIG. 2c the model parameters can be updated for example based on i) the most recently received laboratory test result 206 and ii) the three earlier received laboratory test results 203-205. In FIGS. 2b and 2c, the laboratory test results which are no more used for updating the model parameters are marked with crosses. Therefore, in this exemplifying case, the model parameters are updated so that the laboratory test results used for the updating are those of the laboratory test results which belong to a sliding time-window. In FIG. 2b, a dashed line curve 209 illustrates how the computed estimate of the quality parameter Q would behave if the model parameters were not updated after receiving the laboratory test result 205. Correspondingly, in FIG. 2c, a dashed line curve 210 illustrates how the computed estimate of the quality parameter Q would behave if the model parameters were not updated after receiving the laboratory test result 206. As illustrated by FIGS. 2a-2c, the estimation formula is kept commensurate with the laboratory test results and thus there is no need for re-modeling or other adjustment of the estimation formula.

In a method according to an exemplifying and non-limiting embodiment, the estimation formula F(ρ, T, . . . , p₁, p₂, . . . ) is a first order polynomial of each of the model parameters p₁, p₂, . . . and the model parameters are updated with a regression analysis where the laboratory test results represent a scalar response and measured values of the input variables of the estimation formula corresponding to the laboratory test results represent explanatory variables.

The estimation formula can be for example:

$${Q}_{est} = {p}_{1} \times ρ + {p}_{2} \times T + {p}_{3} \times V + {p}_{4} , \qquad ( 1 )$$

where Qₑₛₜ is the estimate for the quality parameter, p₁, p₂, p₃, and p₄ are the model parameters, ρ is the measured density, T is the measured temperature, and V is a measured volume or mass flow rate of the product or the feed under consideration. It is to be noted that the volume or mass flow rate V is only an example of a measured quantity which can be used as an input variable of the estimation formula in addition to the density ρ and the temperature T. It is also possible that no other quantities in addition to the density and temperature is/are used. In this exemplifying case, the model parameters p₁, p₂, p₃, and p₄ are selected so that a vector norm of an error vector e=[e₁, e₂, . . . e_{N}] is minimized with a suitable known mathematical method. N is the number of the laboratory test results used for updating the model parameters p₁, p₂, p₃, and p₄, and thus N is the dimension of the error vector, and:

$${e}_{i} = {Q}_{Lab , i} - ( {p}_{1} \times {ρ}_{i} + {p}_{2} \times {T}_{i} + {p}_{3} \times {V}_{i} + {p}_{4} ) , \qquad ( 2 )$$

where eᵢ is the i^{th} component of the error vector e, is Q_{Lab,i} is the i^{th} laboratory test result, ρᵢ is the density corresponding to the i^{th} laboratory test result, Tᵢ is the temperature corresponding to the i^{th} laboratory test result, and Vᵢ is the volume or mass flow rate corresponding to the i^{th} laboratory test result.

The above-mentioned vector norm to be minimized can be for example the 2-norm ∥e∥₂ in which case the sum e₁²+e₂²+ . . . +E_{N}² is minimized.

For another example, the estimation formula can be:

$${Q}_{est} = {p}_{1} \times {f}_{1} ( ρ ) + {p}_{2} \times {f}_{2} ( T ) + {p}_{3} , \qquad ( 3 )$$

where f₁ is a suitable pre-selected non-linear function of the density and f₂ is a suitable pre-selected non-linear function of the temperature. In this exemplifying case, no other quantities in addition to the density ρ and the temperature T are used in the estimation. The estimation formula 3 is a first order polynomial of each of the model parameters p₁, p₂, and p₃ even if it is non-linear with respect to the density and the temperature. In this exemplifying case, the i^{th} component of the error vector is:

$${e}_{i} = {Q}_{Lab , i} - ( {p}_{1} \times {f}_{1} ( {ρ}_{i} ) + {p}_{2} \times {f}_{2} ( {T}_{i} ) + {p}_{3} ) , \qquad ( 4 )$$

As equation 4 is linear with respect to parameters p₁, p₂ and p₃, same mathematical methods can be used for minimizing the vector norm of the error vector based on equation 4 as in conjunction with the error vector based on equation 2.

In a method according to an exemplifying and non-limiting embodiment, the model parameters are updated with constrained optimization e.g. constrained least-squares optimization, wherein the constraining is applied to avoid abrupt changes between successively computed estimates of the quality parameter. The constrained optimization can be carried out with for example Quadratic programming “QP” which is also called Quadratic optimization.

In a method according to another exemplifying and non-limiting embodiment, the above-mentioned number N of the newest laboratory test results which are used for the update actions is selected to be so big that the model parameters do not change too much between successive update actions. In other words, the time-window for selecting the laboratory test results for the update actions is so long that the model parameters do not change too much between successive update actions. The bigger is the above-mentioned number N the smaller are the relative effects of the just arrived newest laboratory test result and the laboratory test result that is dropped out from the update action due to the arrival of the newest laboratory test result. Thus, smooth model parameter updating can be achieved by tuning the number N i.e. by tuning the length of the above-mentioned time-window. The tuning can be carried out for example with experiments.

It should be noted that the invention is not limited to any specific methods for updating the model parameters based on the received laboratory test results, but any suitable methods for the updating are applicable.

In a method according to an exemplifying and non-limiting embodiment, each of the laboratory test results is compared to one or more predetermined criteria to sanity check the laboratory test result. The sanity-checked laboratory test result is used for updating the model parameters of the estimation formula only if the one or more predetermined criteria are fulfilled by the laboratory test result. The one or more predetermined criteria may comprise for example one or more of the following: i) a requirement that the laboratory test result is within a predetermined range, ii) a requirement that a deviation between the laboratory test result and a previous laboratory test result is less than a first limit value, iii) a requirement that a rate of change from the previous laboratory test result to the laboratory test result is less than a second limit value, and iv) a requirement that a deviation between the laboratory test result and a corresponding statistical value based on empirical cases is at most a predetermined factor times a standard deviation of the statistical value. Typically, the model parameters are updated at a same rate as the laboratory test results are received, but in a case in which received laboratory test results do not satisfy the sanity-check, the update rate is naturally lower than the rate at which the laboratory test results are received.

A challenge related to regression methods is collinearity, i.e. the input variables density and temperature may correlate. Collinearity introduces numerical instability in the regression calculation and may provide too strongly biased model parameters and thereby weaken accuracy of estimates of quality parameters. To alleviate this potential problem, a method according to an exemplifying and non-limiting embodiment comprises:
computing an auxiliary estimate for the at least one quality parameter Q based on an auxiliary estimation formula Fₐᵤₓ(ρ, . . . , q₁, q₂, . . . ) in which at least one input variable is the measured density ρ and which has auxiliary model parameters q₁, q₂, . . . ,
updating the auxiliary model parameters of the auxiliary estimation formula based on i) the laboratory test results, and ii) measured values of the at least one input variable of the auxiliary estimation formula corresponding to the laboratory test results,
computing a correlation between the measured density ρ and the measured temperature T, and
replacing the estimate for the at least one quality parameter Q with the auxiliary estimate in response to a situation in which an absolute value of the computed correlation exceeds a threshold.

The above-mentioned correlation can be computed for example as the Pearson correlation R for M successive measured values of the density ρ and the temperature T:

$$R = \frac{{\sum }_{i = 1}^{M} ( {ρ}_{i} - {ρ}_{m} ) ( {T}_{i} - {T}_{m} )}{{\sqrt{{\sum }_{i = 1}^{M} (} {ρ}_{i} - {ρ}_{m} )}^{2} {( {T}_{i} - {T}_{m} )}^{2}} \qquad ( 5 )$$

where, ρᵢ is the i^{th} measured value of the density, Tᵢ is the i^{th} measured value of the temperature, ρₘ is the mean value of ρ₁, ρ₂, . . . , and ρₘ, and Tₘ is the mean value of T₁, T₂, . . . , and Tₘ.

In a method according to an exemplifying and non-limiting embodiment, the above-mentioned auxiliary estimation formula Fₐᵤₓ(ρ, . . . , q₁, q₂, . . . ) is a first order polynomial with respect to each of the auxiliary model parameters, and the auxiliary model parameters are updated with a regression analysis where the laboratory test results represent a scalar response and the measured values of the at least one input variable of the auxiliary estimation formula corresponding to the laboratory test results represent an explanatory variable.

The auxiliary estimation formula can be for example:

$${Q}_{aux} = {q}_{1} \times ρ + {q}_{2} , \qquad ( 6 )$$

where Qₐᵤₓ is the auxiliary estimate for the quality parameter, q₁ and q₂ are the auxiliary model parameters, and ρ is the measured density.

For another example, the auxiliary estimation formula can be:

$${Q}_{aux} = {q}_{1} \times {g}_{1} ( ρ ) + {q}_{2} , \qquad ( 7 )$$

where g₁ is a suitable pre-selected non-linear function of the density. The auxiliary estimation formula 7 is a first order polynomial of each of the model parameters q₁ and q₂ even if it is non-linear with respect to the density. Thus, same mathematical methods can be used for minimizing a vector norm of an error vector based on equation 7 as in conjunction with an error vector based on equation 6.

In a method according to an exemplifying and non-limiting embodiment, a time interval between successive measurements of the density ρ and the temperature T of the product or the feed is at most 10 seconds, a time interval between successive computations of the estimate for the at least one quality parameter Q based on the estimation formula F(ρ, T, . . . , p₁, p₂, . . . ) is at most 10 minutes, and a time interval between successive receptions of the laboratory test result is at most 10 days. Typically, the model parameters are updated at a same rate as the laboratory test results are received, but in a case in which received laboratory test results do not satisfy a possible sanity-check, the update rate is naturally lower than the rate at which the laboratory test results are received. It is to be noted that the above-mentioned operations do not necessarily need to be carried out with constant frequencies, but a time interval between successive operations, e.g. successive density and temperature measurements, may vary.

In a method according to an exemplifying and non-limiting embodiment, the density ρ and the temperature T of the product or the feed are measured more frequently than the density ρ and the temperature T are used for computing the estimate for the at least one quality parameter Q based on the estimation formula F(ρ, T, . . . , p₁, p₂, . . . ). Each value of the density ρ used in the computation can be a value formed based on many measured density values to suppress measuring noise and other disturbances. The value of the density ρ used in the computation can be for example an average of density values measured during a moving time window. Correspondingly, each value of the temperature T used in the computation can be a value formed based on many measured temperature values to suppress measuring noise and other disturbances. The value of the temperature T used in the computation can be for example an average of temperature values measured during a moving time window. Values of possible other input variables of the estimation formula can be formed in the same way as the values of the density and the values of the temperature.

Each value of the density ρ and each value of the temperature T, as well as possible other input variables of the estimation formula, which are used in the updating the model parameters can be formed in the same way as the values which are used in the computation of the estimate. It is also possible that the values used in the updating the model parameters are formed in a different way than the values used in the computation. The invention is not limited to any specific ways to form or select the values used in the computation, nor to any specific ways to form or select the values used in the updating.

In a method according to an exemplifying and non-limiting embodiment, laboratory test results are received from two or more laboratories and a value used for updating the model parameters is formed with a predetermined rule from two or more received laboratory test results in response to a situation in which i) the two or more received laboratory test results are received from different laboratories and ii) the two or more received laboratory test results represent a same quantity and are based on a same sample of a product or a feed. In an exemplifying case, test results are received more frequently from a first laboratory than from a second laboratory, but the test results received from the second laboratory are more reliable than the test results received from the first laboratory. In this exemplifying case, a value used for updating the model parameters can be a test result received from the first laboratory when no test result is available from the second laboratory and the value used for updating the model parameters can be a weighted average of test results received from the first and second laboratories when the test result have been received from the second laboratory, too. A weighting factor of the test result received from the second laboratory is advantageously greater than a weighting factor of the test result received from the first laboratory because the test result received from the second laboratory is more reliable.

A computer program according to an exemplifying and non-limiting embodiment comprises computer executable instructions for controlling a programmable data processing system to carry out actions related to a method according to any of the above-described exemplifying embodiments.

A computer program according to an exemplifying and non-limiting embodiment comprises software modules for estimating at least one quality parameter related to a product or a feed of processing of organic substances. The software modules comprise computer executable instructions for controlling a programmable data processing system to:
repeatedly receive measured values of density ρ and temperature T of the product or the feed,
repeatedly compute an estimate for the at least one quality parameter Q based on an estimation formula F(ρ, T, . . . , p₁, p₂, . . . ) whose input variables comprise the measured density and the temperature,
repeatedly receive laboratory test results Q_{Lab} indicative of the at least one quality parameter Q, and
repeatedly update model parameters p₁, p₂, . . . of the estimation formula based on i) the received laboratory test results and on ii) measured values of the input variables of the estimation formula corresponding the laboratory test results, the model parameters defining a dependence of changes of the estimate on changes of the input variables which comprise the density and the temperature.

The above-mentioned software modules can be e.g. subroutines or functions implemented with a suitable programming language.

A computer program product according to an exemplifying and non-limiting embodiment comprises a computer readable medium, e.g. a compact disc “CD”, encoded with a computer program according to an embodiment of the invention.

A signal according to an exemplifying and non-limiting embodiment is encoded to carry information defining a computer program according to an embodiment of the invention.

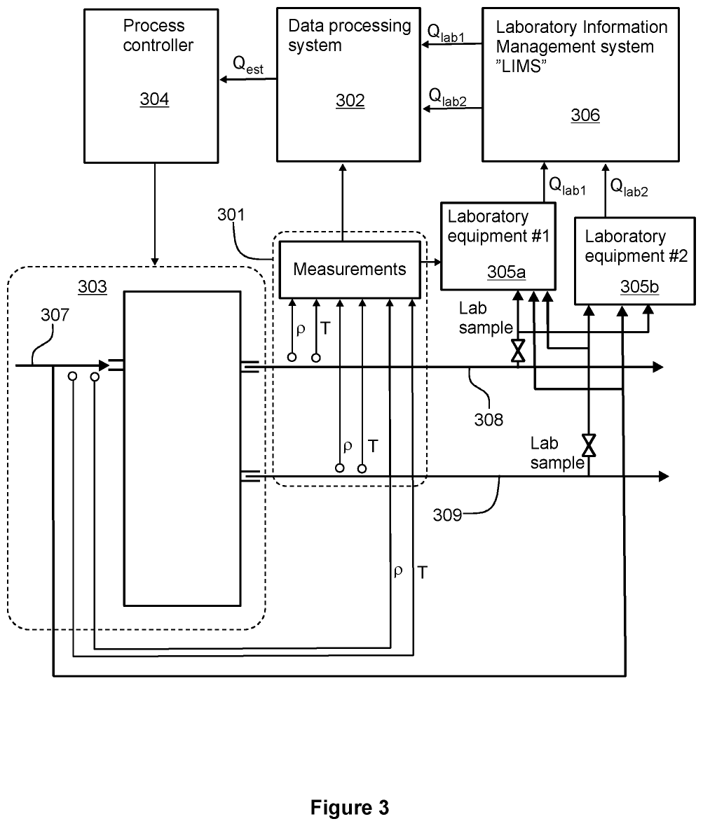

FIG. 3 illustrates a system according to an exemplifying and non-limiting embodiment for processing organic substances, e.g. tall oil or heavy gas oil. The system comprises processing equipment 303 configured to receive a feed 307 containing the organic substances and to obtain products 308 and 309 from the organic substances. The processing equipment 303 may comprise for example a distillation column. The system comprises an apparatus according to an embodiment of the invention and configured to repeatedly estimate at least one quality parameter related to the feed 307, at least one quality parameter related to the product 308, and at least one quality parameter related to the product 309. The quality parameters can be indicative of for example: i) rosin product softening point, i) rosin product rosin acid content, iii) rosin acid content of a fatty acid product, iv) rosin acid content of crude fatty acid, v) rosin acid content of crude tall oil, vi) a color index of heavy gas oil, and/or vii) weight fractions of compounds in polyalphaolefin products or intermediates. The system comprises a process controller 304 configured to control conditions within the processing equipment 303 based on the estimated quality parameters. The conditions within the processing equipment 303 can be controlled for example by controlling a volume or mass flow rate of the feed 307, volume or mass flow rates of the products 308 and 309, and/or by controlling temperature, pressure, a feed rate of catalysts and/or inhibitors, and/or other conditions prevailing in the processing equipment 303. A feed line and product lines of the system are connected to laboratory equipment 305a and to laboratory equipment 305b with sample taking lines configured to deliver samples of the feed 307 and samples of the products 308 and 309 to the laboratory equipment 305a and to the laboratory equipment 305b. Both these laboratory equipment 305a and 305b produce laboratory test results, but it is possible that e.g. the laboratory equipment 305a produces laboratory test results Q_{lab1} more frequently than the laboratory equipment 305b produces laboratory test results Q_{lab2} but, on the other hand, the laboratory test results Q_{lab2} can be more reliable than the laboratory test results Q_{lab1}.

The apparatus for estimating the quality parameters comprises measurement devices 301 configured to repeatedly measure density ρ and temperature T of each of the feed 307 and the products 308 and 309. The apparatus comprises a data processing system 302 configured to repeatedly compute an estimate for each of the quality parameters based on an estimation formula F(ρ, T, . . . , p₁, p₂, . . . ) related to the quality parameter under consideration. The input variables of each estimation formula comprise the measured density and the temperature, and the estimation formula has model parameters defining a dependence of changes of the estimate on changes of the input variables which comprise the density and the temperature. The data processing system 302 is configured to repeatedly receive laboratory test results Q_{Lab} indicative of each of the quality parameters. In the exemplifying case illustrated in FIG. 3, the data processing system 302 is configured to receive the laboratory test results Q_{Lab} via a Laboratory Information Management system “LIMS”. The data processing system 302 is configured to repeatedly update model parameters (p₁, p₂, . . . ) of each estimation formula based on i) the received laboratory test results and on ii) measured values of the input variables of the estimation formula corresponding to the received laboratory test results. Concerning samples of the feed 307 and the products 308 and 309 for which the laboratory test results Q_{lab1} are made but not Q_{lab2}, the laboratory test results Q_{lab1} can be used as values for updating the model parameters and, concerning samples for which both laboratory test results Q_{lab1} and Q_{lab2} are made, for example weighted averages of Q_{lab1} and Q_{lab2} can be used as values for updating the model parameters.

In an apparatus according to an exemplifying and non-limiting embodiment, each estimation formula F(ρ, T, . . . , p₁, p₂, . . . ) is a first order polynomial with respect to each of its model parameters. The data processing system 302 is configured to update the model parameters with a regression analysis where the laboratory test results represent a scalar response and the measured values of the input variables of the estimation formula corresponding to the laboratory test results represent explanatory variables. The estimation formula can be for example:

$${Q}_{est} = {p}_{1} \times ρ + {p}_{2} \times T + {p}_{3} , \qquad ( 8 )$$

where Qₑₛₜ is the estimate for the quality parameter, p₁, p₂, and p₃ are the model parameters, ρ is the measured density, and T is the measured temperature.

In an apparatus according to an exemplifying and non-limiting embodiment, the data processing system 302 is configured to update the model parameters with constrained optimization e.g. constrained least-squares optimization, wherein the constraining is applied to avoid abrupt changes between successively computed estimates of the at least one quality parameter. In an apparatus according to another exemplifying and non-limiting embodiment, the number of newest laboratory test results used for each update action has been selected to be so big that the model parameters do not change too much between successive update actions. In other words, the time-window for selecting the laboratory test results for the update actions is so long that the model parameters do not change too much between successive update actions.

In an apparatus according to an exemplifying and non-limiting embodiment, the data processing system 302 is configured to compare each of the laboratory test results to one or more predetermined criteria to sanity check the laboratory test result, and to use the sanity-checked laboratory test result for updating the model parameters of the corresponding estimation formula only if the one or more predetermined criteria are fulfilled by the laboratory test result. The one or more predetermined criteria may comprise for example one or more of the following: i) a requirement that the laboratory test result is within a predetermined range, ii) a requirement that a deviation between the laboratory test result and a previous laboratory test result is less than a first limit value, iii) a requirement that a rate of change from the previous laboratory test result to the laboratory test result is less than a second limit value, and iv) a requirement that a deviation between the laboratory test result and a corresponding statistical value based on empirical cases is at most a predetermined factor times a standard deviation of the statistical value.

In an apparatus according to an exemplifying and non-limiting embodiment, the data processing system 302 is configured to compute an auxiliary estimate for each quality parameter based on an auxiliary estimation formula Fₐᵤₓ(ρ, . . . , q₁, q₂, . . . ) related to the quality parameter under consideration. At least one input variable of each auxiliary estimation formula is the measured density ρ of the corresponding feed or the product, and the auxiliary estimation formula has auxiliary model parameters q₁, q₂, . . . . The data processing system 302 is configured to update the auxiliary model parameters of each auxiliary estimation formula based on i) the laboratory test results, and ii) measured values of the at least one input variable of the auxiliary estimation formula corresponding to the laboratory test results. Concerning each of the feed 307 and the products 308 and 309, the data processing system 302 is configured to compute a correlation between the measured density ρ and the measured temperature T. The correlation can be computed for example as the Pearson correlation. The data processing system 302 is configured to replace the estimate of each quality parameter with the corresponding auxiliary estimate in response to a situation in which an absolute value of the corresponding correlation exceeds a threshold.

In an apparatus according to an exemplifying and non-limiting embodiment, each auxiliary estimation formula Fₐᵤₓ(ρ, . . . , q₁, q₂, . . . ) is a first order polynomial with respect to each of the auxiliary model parameters. The data processing system is configured to update the auxiliary model parameters with a regression analysis where the laboratory test results represent a scalar response and the measured values of the at least one input variable of the auxiliary estimation formula corresponding to the laboratory test results represent an explanatory variable. The auxiliary estimation formula can be for example:

$${Q}_{aux} = {q}_{1} \times ρ + {q}_{2} , \qquad ( 9 )$$

where Qₐᵤₓ is the auxiliary estimate for the quality parameter, q₁ and q₂ are the auxiliary model parameters, and ρ is the measured density. In this exemplifying case, no other measured quantity is used in the estimation in addition to the density ρ.

In an apparatus according to an exemplifying and non-limiting embodiment:
the measurement devices 301 are configured to repeatedly measure the density ρ and the temperature T from each of the feed 307 and/or the products 308 and 309 so that each time-interval between two successive measurements of the density and the temperature is at most 10 seconds,
the data processing system 302 is configured to repeatedly compute the estimate for each quality parameter so that each time-interval between two successive computations of the estimate is at most 10 minutes,
the data processing system 302 is configured to repeatedly receive the laboratory test result so that each time-interval between two successive receptions of the laboratory test results is at most 10 days, and
the data processing system 302 is configured to update the model parameters based on the received laboratory test results in response to a situation in which the received laboratory test results fulfil one or more predetermined sanity-check criteria.

In an apparatus according to an exemplifying and non-limiting embodiment, the measurement devices 301 are configured to measure the density ρ and the temperature T from each of the feed 307 and/or the products 308 and 309 more frequently than the density ρ and the temperature T are used for computing the estimate for the at least one quality parameter Q based on the estimation formula F(ρ, T, . . . , p₁, p₂, . . . ). The data processing system 302 is configured to form each value of the density ρ used in the computation based on many measured density values and to form each value of the temperature T used in the computation based on many measured temperature values.

The data processing system 302 may comprise one or more processor circuits, each of which can be a programmable processor circuit provided with appropriate software, a dedicated hardware processor for example an application specific integrated circuit “ASIC”, or a configurable hardware processor for example a field programmable gate array “FPGA”. The data processing system 302 may comprise one or more memory circuits each of which can be e.g. a random access memory circuit “RAM”.

The specific examples provided in the description given above should not be construed as limiting. Therefore, the invention is not limited merely to the exemplifying and non-limiting embodiments described above. Lists and groups of examples provided in the description are not exhaustive unless otherwise explicitly stated.

1. A method for estimating at least one quality parameter (Q) related to a product or a feed of processing of organic substances, the method comprising:
repeatedly measuring density (ρ) and temperature (T) of the product or the feed;
repeatedly computing an estimate for the at least one quality parameter based on an estimation formula whose input variables include the measured density and the measured temperature;
repeatedly receiving laboratory test results (Q_{Lab}) indicative of the at least one quality parameter; and
repeatedly updating model parameters (p₁, p₂, . . . ) of the estimation formula based on: i) the received laboratory test results, and on ii) measured values of the input variables of the estimation formula corresponding to the received laboratory test results, the model parameters defining a dependence of changes of the estimate on changes of the input variables including the density and the temperature.

2. A method according to claim 1, wherein the estimation formula is a first order polynomial of each of the model parameters, and the model parameters are updated with a regression analysis where the laboratory test results represent a scalar response and the measured values of the input variables of the estimation formula corresponding to the laboratory test results represent explanatory variables.

3. A method according to claim 2, wherein the estimation formula is:
$${Q}_{est} = {p}_{1} \times r + {p}_{2} \times T + {p}_{3} ,$$
where Qₑₛₜ is the estimate for the quality parameter, p₁, p₂, and p₃ are the model parameters, r is the measured density, and T is the measured temperature.

4. A method according to claim 1, comprising:
comparing each of the laboratory test results to one or more predetermined criteria to sanity check the laboratory test result; and
using the laboratory test result for updating the model parameters of the estimation formula only if the one or more predetermined criteria are fulfilled by the laboratory test result.

5. A method according to claim 4, wherein the one or more predetermined criteria comprise one or more of the following:
i) a requirement that the laboratory test result is within a predetermined range, ii) a requirement that a deviation between the laboratory test result and a previous laboratory test result is less than a first limit value, iii) a requirement that a rate of change from the previous laboratory test result to the laboratory test result is less than a second limit value, and iv) a requirement that a deviation between the laboratory test result and a corresponding statistical value based on empirical cases is at most a predetermined factor times a standard deviation of the statistical value.

6. A method according to claim 1, comprising:
updating the model parameters with constrained optimization in which constraining is applied to avoid abrupt changes between successively computed estimates of the at least one quality parameter (Q).

7. A method according to claim 1, comprising:
computing an auxiliary estimate for the at least one quality parameter based on an auxiliary estimation formula in which at least one input variable is the measured density and which has auxiliary model parameters (q₁, q₂, . . . );
updating the auxiliary model parameters of the auxiliary estimation formula based on: i) the laboratory test results and ii) measured values of the at least one input variable of the auxiliary estimation formula corresponding to the laboratory test results;
computing a correlation between the measured density and the measured temperature; and
replacing the estimate for the at least one quality parameter with the auxiliary estimate in response to a situation in which an absolute value of the computed correlation exceeds a threshold.

8. A method according to claim 7, wherein the auxiliary estimation formula is a first order polynomial with respect to each of the auxiliary model parameters, and the auxiliary model parameters are updated with a regression analysis where the laboratory test results represent a scalar response and the measured values of the at least one input variable of the auxiliary estimation formula corresponding to the laboratory test results represent an explanatory variable.

9. A method according to claim 8, wherein the auxiliary estimation formula is:
$${Q}_{aux} = {q}_{1} \times r + {q}_{2} ,$$
where Qₐᵤₓ is the auxiliary estimate for the quality parameter, q₁ and q₂ are the auxiliary model parameters, and r is the measured density.

10. A method according to claim 1, wherein the feed comprises:
organic substances whose molecules have at least 10 carbon atoms.

11. A method according to claim 10, wherein the processing of the organic substances is a tall oil distillation process, a heavy gas oil fractionation process, or a base oil fractionation process.

12. A method according to claim 10, wherein the at least one quality parameter is indicative of one of the following: i) rosin product softening point, i) rosin product rosin acid content, iii) rosin acid content of a fatty acid product, iv) rosin acid content of crude fatty acid, v) rosin acid content of crude tall oil, vi) a color index of heavy gas oil, and vii) weight fractions of compounds in polyalphaolefin products or intermediates.

13. A method according to claim 1, comprising:
receiving the laboratory test results from two or more laboratories; and
forming a value used for updating the model parameters with a predetermined rule from two or more of the received laboratory test results in response to a situation in which: i) the two or more of the received laboratory test results are received from different laboratories, and ii) the two or more of the received laboratory test results represent a same quantity and are based on a same sample of the product or the feed.

14. A method according to claim 1, wherein:
each time-interval between two successive measurements of the density and the temperature is at most 10 seconds;
each time-interval between two successive computations of the estimate is at most 10 minutes;
each time-interval between two successive receptions of the laboratory test results is at most 10 days; and
the model parameters are updated based on the received laboratory test results in response to a situation in which the received laboratory test results fulfil one or more predetermined criteria.

15. A method for processing organic substances, the method comprising:
supplying a feed containing the organic substances into processing equipment where at least one product is obtained from the organic substances;
repeatedly estimating at least one quality parameter related to the at least one product or to the feed; and
controlling conditions within the processing equipment based on the estimated at least one quality parameter;
wherein the estimating the at least one quality parameter includes:
repeatedly measuring density and temperature of the at least one product or the feed;
repeatedly computing an estimate for the at least one quality parameter based on an estimation formula whose input variables include the measured density and the measured temperature;
repeatedly receiving laboratory test results indicative of the at least one quality parameter; and
repeatedly updating model parameters of the estimation formula based on: i) the received laboratory test results and on ii) measured values of the input variables of the estimation formula corresponding to the received laboratory test results, the model parameters defining a dependence of changes of the estimate on changes of the input variables including the density and the temperature.

16. An apparatus for estimating at least one quality parameter (Q) related to a product or a feed of processing of organic substances, the apparatus comprising:
measurement devices configured to repeatedly measure density (ρ) and temperature (T) of the product or the feed; and
a data processing system configured to repeatedly compute an estimate for the at least one quality parameter based on an estimation formula whose input variables include the measured density and the measured temperature, wherein the data processing system is configured to:
repeatedly receive laboratory test results (Q_{Lab}) indicative of the at least one quality parameter; and
repeatedly update model parameters (p₁, p₂, . . . ) of the estimation formula based on: i) the received laboratory test results and on ii) measured values of the input variables of the estimation formula corresponding to the received laboratory test results, the model parameters defining a dependence of changes of the estimate on changes of the input variables including the density and the temperature.

17. A system for processing organic substances with an apparatus for processing, the system comprising:
processing equipment configured to receive a feed containing the organic substances and obtain at least one product from the organic substances;
an apparatus for estimating, the apparatus for estimating being configured to repeatedly estimate at least one quality parameter related to the at least one product or to the feed; and
a the process controller configured to control conditions within the processing equipment based on the estimated at least one quality parameter;
wherein the apparatus for estimating includes measurement devices configured to repeatedly measure density and temperature of the at least one product or the feed, and a data processing system configured to:
repeatedly compute an estimate for the at least one quality parameter based on an estimation formula whose input variables include the measured density and the measured temperature;
repeatedly receive laboratory test results indicative of the at least one quality parameter; and
repeatedly update model parameters of the estimation formula based on: i) the received laboratory test results, and on ii) measured values of the input variables of the estimation formula corresponding to the received laboratory test results, the model parameters defining a dependence of changes of the estimate on changes of the input variables including the density and the temperature.

18. A non-volatile computer readable medium encoded with a computer program for estimating at least one quality parameter (Q) related to a product or a feed of processing of organic substances, the computer program comprising:
computer executable instructions for controlling a programmable data processing system to:
repeatedly receive measured values of density (ρ) and temperature (T) of the product or the feed;
repeatedly compute an estimate for the at least one quality parameter based on an estimation formula whose input variables include the measured density and the measured temperature,
repeatedly receive laboratory test results (Q_{Lab}) indicative of the at least one quality parameter; and
repeatedly update model parameters (p₁, p₂, . . . ) of the estimation formula based on: i) the received laboratory test results, and on ii) measured values of the input variables of the estimation formula corresponding the laboratory test results, the model parameters defining a dependence of changes of the estimate on changes of the input variables comprising including the density and the temperature.
